(19) United States
(12) Patent Application Publication
(10) Pub. No.: US 2026/0268217 A1
(43) Pub. Date: Sep. 10, 2026

(54) INFORMATION PROCESSING DEVICE, LEARNING METHOD, AND LEARNING PROGRAM

(71) Applicant: NEC Corporation, Tokyo (JP)

(72) Inventors: Akira KITAOKA, Tokyo (JP); Riki ETO, Tokyo (JP)

(73) Assignee: NEC Corporation, Tokyo (JP)

(21) Appl. No.: 19/471,384

(22) PCT Filed: Apr. 11, 2023
(86) PCT No.: PCT/JP2023/014646

§ 371 Date: Oct. 1, 2025

(51) Int. Cl. G06N 20/00

(52) U.S. Cl. CPC G06N 20/00

(57) ABSTRACT

In order to prevent learning failures in inverse reinforcement learning, this information processing device (1), which uses inverse reinforcement learning to calculate weights in a reward function represented by a weighted linear sum of feature amounts to facilitate decision making, comprises: a weight update unit (11) that updates the weights; a projection unit (12) that projects the updated weights onto a predetermined space or set; and a determination unit (13) that determines whether or not to update the weights on the basis of the projected weights.

### TECHNICAL FIELD

The present disclosure relates to an information processing device and the like that perform inverse reinforcement learning.

### BACKGROUND ART

PTL 1 discloses a technique for deriving a reward function (also referred to as an objective function) by inverse reinforcement learning. Specifically, PTL 1 discloses a learning device that derives a reward function by repeatedly performing processing of estimating a trajectory that minimizes a Wasserstein distance between a probability distribution of a trajectory indicating behavior of a skilled person in each state and a probability distribution of a trajectory determined based on a parameter of the reward function, and updating the parameter of the reward function based on the estimated trajectory.

### CITATION LIST

### Patent Literature

PTL 1: WO 2022/230019 A1

### SUMMARY OF INVENTION

### Technical Problem

The technique of PTL 1 has room for improvement in terms of preventing learning failure. For example, in updating the parameter of the reward function, the updated parameter may converge at an undesirable value of zero. The parameter of the reward function may diverge infinitely, and the calculation may not converge.

An aspect of the present disclosure has been made in view of the above problems, and an object thereof is to provide an information processing device and the like that enable prevention of learning failure in inverse reinforcement learning.

### Solution to Problem

An information processing device according to one aspect of the present disclosure is an information processing device that calculates a weight in a reward function represented by a weighted linear sum of feature amounts by inverse reinforcement learning, the information processing device including a weight update means for updating the weight, a projection means for projecting the updated weight to a predetermined space or set, and a determination means for determining necessity of updating the weight based on the projected weight.

A learning method according to one aspect of the present disclosure is a learning method for calculating a weight in a reward function represented by a weighted linear sum of feature amounts by inverse reinforcement learning, the learning method causing at least one processor to execute updating the weight, projecting the updated weight to a predetermined space or set, and determining necessity of updating the weight based on the projected weight.

A learning program according to one aspect of the present disclosure is a learning program that calculates a weight in a reward function represented by a weighted linear sum of feature amounts by inverse reinforcement learning, the learning program causing a computer to function as a weight update means for updating the weight, a projection means for projecting the updated weight to a predetermined space or set, and a determination means for determining necessity of updating the weight based on the projected weight.

### Advantageous Effects of Invention

According to one aspect of the present disclosure, it is possible to prevent learning failure in inverse reinforcement learning.

### BRIEF DESCRIPTION OF DRAWINGS

FIG. 1 is a block diagram illustrating a configuration of an information processing device according to a first exemplary example embodiment of the present disclosure.

FIG. 2 is a flowchart illustrating a flow of a learning method according to the first exemplary example embodiment of the present disclosure.

FIG. 3 is a block diagram illustrating a configuration of an information processing device according to a second exemplary example embodiment of the present disclosure.

FIG. 4 is a flowchart illustrating a flow of a learning method according to the second exemplary example embodiment of the present disclosure.

FIG. 5 is a diagram illustrating an example of a computer that executes a command of a program that is software for achieving each function of each device according to each exemplary example embodiment.

### EXAMPLE EMBODIMENT

### First Exemplary Example Embodiment

A first exemplary example embodiment of the present disclosure will be described in detail with reference to the drawings. The present exemplary example embodiment is a basic form of the exemplary example embodiment described below.

### (Configuration of Information Processing Device 1)

A configuration of an information processing device 1 according to the present exemplary example embodiment will be described with reference to FIG. 1. FIG. 1 is a block diagram illustrating a configuration of the information processing device 1. The information processing device 1 is a device that calculates a weight in a reward function represented by a weighted linear sum of feature amounts by inverse reinforcement learning, and includes a weight update unit 11, a projection unit 12, and a determination unit 13 as illustrated in FIG. 1.

The weight update unit 11 updates the weight in the reward function described above.

The projection unit 12 projects the weight updated by the weight update unit 11 to a predetermined space or set.

The determination unit 13 determines necessity of updating the weight based on the weight projected by the projection unit 12.

As described above, the information processing device 1 according to the present exemplary example embodiment is an information processing device that calculates a weight in a reward function represented by a weighted linear sum of feature amounts by inverse reinforcement learning, and employs a configuration including the weight update unit 11 that updates the weight, the projection unit 12 that projects the updated weight onto a predetermined space or set, and the determination unit 13 that determines necessity of updating the weight based on the projected weight. Therefore, according to the information processing device 1 according to the present exemplary example embodiment, it is possible to obtain an effect of preventing learning failure in inverse reinforcement learning.

### (Learning Program)

The functions of the information processing device 1 described above can also be achieved by a program. A learning program of inverse reinforcement learning according to the present exemplary example embodiment is a learning program that calculates a weight in a reward function represented by a weighted linear sum of feature amounts by inverse reinforcement learning, and causes a computer to function as a weight update means for updating the weight of the reward function, a projection means for projecting the updated weight onto a predetermined space or set, and a determination means for determining necessity of updating the weight based on the projected weight. According to this learning program, it is possible to prevent learning failure in the inverse reinforcement learning.

### (Flow of Learning Method)

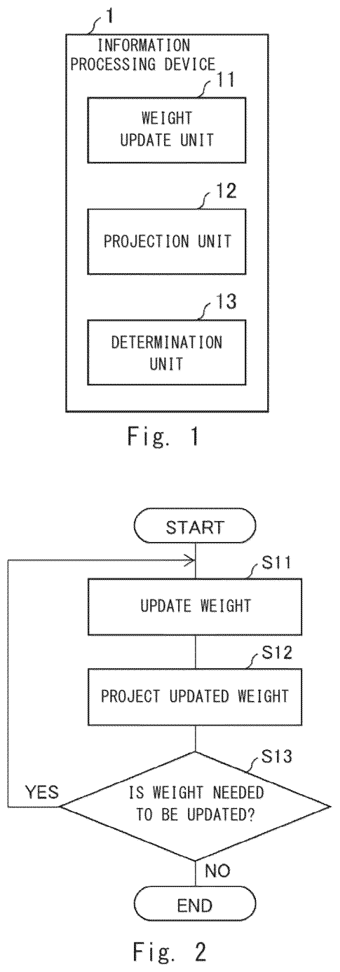

A flow of a learning method according to the present exemplary example embodiment will be described with reference to FIG. 2. FIG. 2 is a flowchart illustrating the flow of the learning method. In this learning method, a weight in a reward function represented by a weighted linear sum of feature amounts is calculated by inverse reinforcement learning. An executing entity of each step in this learning method may be a processor included in the information processing device 1, may be a processor included in another device, or an executing entity of each step may be a processor provided in each of different devices.

In S11, at least one processor updates the weight in the reward function described above.

In S12, the at least one processor projects the weights updated in S11 to a predetermined space or set.

In S13, at least one processor determines necessity of updating the weight based on the weight projected in S12. In a case where it is determined in S13 that updating of the weight is unnecessary (NO in S13), the illustrated learning method ends. On the other hand, in a case where it is determined in S13 that updating of the weight is necessary (YES in S13), the process returns to S11.

As described above, the learning method according to the present exemplary example embodiment is a learning method for calculating a weight in a reward function represented by a weighted linear sum of feature amounts by inverse reinforcement learning, and employs a configuration in which at least one processor executes updating the weight of the reward function, projecting the updated weight to a predetermined space or set, and determining necessity of updating the weight based on the projected weight. Therefore, according to the learning method according to the present exemplary example embodiment, it is possible to obtain an effect of preventing learning failure in inverse reinforcement learning.

### Second Exemplary Example Embodiment

### (Configuration of Information Processing Device 2)

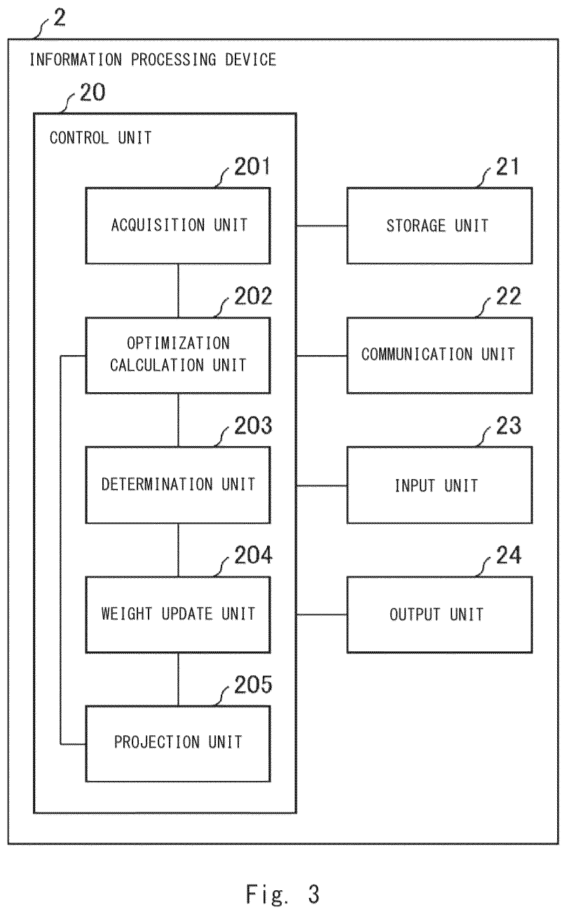

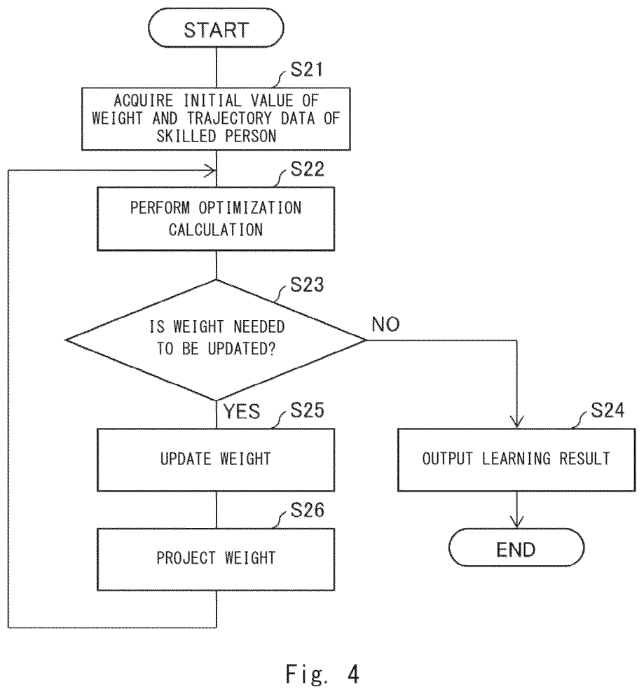

A configuration of an information processing device 2 according to the present exemplary example embodiment will be described with reference to FIG. 3. FIG. 3 is a block diagram illustrating the configuration of the information processing device 2. The information processing device 2 is a device that performs inverse reinforcement learning.

The inverse reinforcement learning is to learn a weight in a reward function represented by a weighted linear sum of feature amounts. The reward function defines a relationship of reward with respect to a combination of a state and an action performed in the state, and an action that maximizes reward can be obtained by using a learned reward function.

As illustrated, the information processing device 2 includes a control unit that integrally controls each unit of the information processing device 2 and a storage unit 21 that is a storage device that stores various data used by the information processing device 2. The control unit 20 includes an acquisition unit 201, an optimization calculation unit 202, a determination unit 203, a weight update unit 204, and a projection unit 205.

The information processing device 2 includes a communication unit 22 for the information processing device 2 to communicate with another device, an input unit 23 that receives an input to the information processing device 2, and an output unit 24 for the information processing device 2 to output data. The information processing device 2 may be a device dedicated to inverse reinforcement learning, or may be a general-purpose device that can be used for other applications.

The acquisition unit 201 acquires various types of data necessary for the inverse reinforcement learning. Specifically, the acquisition unit 201 acquires an initial value of the weight and predetermined trajectory data. The predetermined trajectory data is data indicating an appropriate action in each state, and may be, for example, trajectory data of a skilled person or expert data.

The optimization calculation unit 202 solves a mathematical optimization problem for calculating a state and an action that maximize a reward calculated by a reward function represented by using a weight during learning. The solution of the mathematical optimization problem is not particularly limited, and for example, the optimization calculation unit 202 may perform mathematical optimization calculation by a known mathematical optimization solver.

The determination unit 203 determines necessity of updating the weight based on the result of the optimization calculation by the optimization calculation unit 202. A method of determining necessity of updating the weight will be described later.

The weight update unit 204 updates the weight in a case where the determination unit 203 determines that the update is necessary. A method of updating the weight is not particularly limited. For example, the weight update unit 204 may update the weight by a gradient method or may update the weight by a method such as adaptive moment estimation (Adam) or momentum.

The projection unit 205 projects the weight updated by the weight update unit 204 to a predetermined space or set. This will be described below in detail.

As described above, the information processing device 2 is an information processing device that calculates a weight in a reward function represented by a weighted linear sum of feature amounts by inverse reinforcement learning, and includes the weight update unit 204 that updates the weight of the reward function, the projection unit 205 that projects the updated weight onto a predetermined space or set, and the determination unit 203 that determines necessity of updating the weight based on the projected weight. According to this configuration, since the updated weight is projected to a predetermined space or set, it is possible to prevent learning failure (optimum weight value becomes zero, weight value does not converge, or the like) that may occur in a case where projection is not performed.

### (Inverse Reinforcement Learning)

It can be said that one of the inverse reinforcement learning is to solve the inverse optimization problem shown in the following Expression (1). s⁽ⁿ⁾ is the state, a⁽ⁿ⁾ is the action of the skilled person, and @ is the parameter space of the trajectory data. n is a label, and n=1, . . . , N.

$$[ Mathematical 1 ]$$

$${arg min}_{ϕ ∈ Φ} ( {\sum }_{n = 1}^{N} {max}_{x ∈ X ( {s}^{( n )} )} {ϕ}^{T} h ( x ) - {\sum }_{n = 1}^{N} {ϕ}^{T} {a}^{( n )} ) \qquad ( 1 )$$

That is, the inverse reinforcement learning is to obtain the weight φ that minimizes the difference between the reward function of the learner indicated in the first term in parentheses in Expression (1) (that is, the reward function to be obtained) and the reward function of the skilled person indicated in the second term.

### (Optimization Calculation and Weight Update)

The optimization calculation unit 202 solves a mathematical optimization problem for calculating a state and an action that maximize a reward calculated by a reward function by using a weight during learning. A method of the optimization calculation by the optimization calculation unit 202 is not particularly limited, and a method of updating the weight by the weight update unit 204 is also not particularly limited. Then, a method of determining necessity of updating the weight by the determination unit 203 may be relevant to a method of optimization calculation by the optimization calculation unit 202.

For example, the weight update unit 204 may update the weight φ so that the objective function F_{β}(φ) expressed by the following Expression (2) is minimized. f_{(·)} is a feature vector.

$$[ Mathematical 2 ]$$

$$F \text{?} := ( \frac{1}{N} {\sum }_{n = 1}^{N} {ϕ}^{T} f \text{?} - \frac{1}{N} {\sum }_{n = 1}^{N} {ϕ}^{T} f \text{?} ) + β ( {ϕ}^{T} f \text{?} - \frac{1}{N} {\sum }_{n = 1}^{N} {ϕ}^{T} f \text{?} ) \qquad ( 2 )$$

$$\text{?} \text{indicates text missing or illegible when filed}$$

τ_{φ}^{max} in Expression (2) is expressed as follows.

$$[ Mathematical 3 ]$$

$${τ}_{ϕ}^{max} ∈ {arg max}_{τ ∈ D ( ϕ )} {ϕ}^{T} {f}_{τ} , D ( ϕ ) := \{ {τ}_{E}^{( n )} , {g}_{ϕ} ( {s}_{ini}^{( n )} ) \vert n \}$$

β is a predetermined coefficient, β ∈ [0, 1], and τ_{φ}∈ T are trajectory data of the skilled person, Sini (n) is an initial state of the skilled person, and go (Sini (n)) is trajectory data of the learner.

The first term on the right side of Expression (2) is a Wasserstein distance indicating a deviation degree between the probability distribution of the trajectory data of the skilled person and the probability distribution of the trajectory data of the learner determined based on the weight of the reward function.

On the other hand, the second term on the right side of Expression (2) is an entropy regularization term. The entropy regularization term represents a difference between the feature amount of the trajectory data from which the maximum reward is obtained and the average value of the feature amounts of the trajectory data. Although it is not essential to include the entropy regularization term in the objective function F_{β}(φ), inclusion of the entropy regularization term can solve the problem of indefiniteness that occurs if there are a plurality of reward functions.

In a case where the weight update unit 204 updates the weight so as to minimize the objective function F_{β}(φ) indicated by Expression (2), the optimization calculation unit 202 calculates a Wasserstein distance that is a difference between the average value of the reward calculated using the weight being learned and the average value of the reward calculated using the weight and the state and action indicated in the trajectory data of the skilled person, and calculates the value of the entropy regularization term.

Then, the determination unit 203 determines that it is not necessary to update the weight in a case where the value of the calculated objective function F_{β}(φ) exceeds a predetermined threshold value, and determines that it is necessary to update the weight in a case where the value of the objective function F_{β}(φ) is equal to or less than the predetermined threshold value.

Then, in a case where it is determined that the weight update is necessary, the weight update unit 204 updates the weight so that the objective function F_{β}(P) is minimized. The update may be performed by any method such as a gradient method. The algorithm of the inverse reinforcement learning is arbitrary and is not limited to the above example. For example, a learning algorithm such as maximum entropy inverse reinforcement learning (MEIRL) or guided cost learning (GCL) may be applied.

### (Projection)

In the inverse reinforcement learning, an optimum weight is searched while repeating weight update as described above. However, since the value of Expression (2) becomes 0 if the weight φ=0, an undesired result that the optimum weight value is zero may be calculated. Learning may fail due to the weight values not converging.

The projection unit 205 projects the weight updated by the weight update unit 204 as described above to a predetermined space or set, thereby preventing learning failure as described above.

For example, the projection unit 205 may project the updated weight to a closed subset of a vector space that does not include a zero vector of which all elements are zero. That is, the predetermined space or set may be a closed subset of a vector space that does not include a zero vector.

As a result, it is ensured that the weight does not become the zero vector during the update, and thus, in addition to the effect obtained by the information processing device 1 according to the first exemplary example embodiment, it is possible to obtain an effect of preventing learning failure due to the optimum weight value becoming zero.

For example, the projection unit 205 may project the updated weight to a bounded closed convex set. That is, the predetermined space or set may be a bounded closed convex set. As a result, it is ensured that the weight being updated is an element of the bounded closed convex set, and thus, in addition to the effect obtained by the information processing device 1 according to the first exemplary example embodiment, it is possible to obtain an effect of preventing learning failure due to the weight values not converging.

For example, in the linear programming used in the knapsack problem, the shift scheduling problem, the optimum transport problem, and the like, φ^{T}h (x)=φ^{T}x in the above Expression (1) is expressed. In this case, the projection unit 205 may project the updated weight φ to the following space Φ.

$$[ Mathematical 4 ]$$

$$Φ = \{ ϕ \vert ϕ \geq 0 , {\sum }_{i} {ϕ}_{i} = 1 \}$$

Since the space Φ is a bounded closed convex set, by projecting the space Φ, it is possible to prevent learning failure due to the weight value not converging and to prevent learning failure due to the optimum weight value becoming zero.

The projection method is not particularly limited, and for example, the method described in “Projection onto the probability simplex: An efficient algorithm with a simple proof, and an application” (Weiran Wang, Miguel A. Carreira-Perpinan, Electrical Engineering and Computer Science, Sep. 3, 2013) may be applied.

In a case where the projection as described above is performed, at first glance, the weight search space becomes narrow, and it seems that an appropriate weight cannot be learned. However, in the inverse reinforcement learning, the value of arg max φ^{T}h (x) for x ∈ X (s⁽ⁿ⁾) does not change between φ and cφ (c is a positive real number). Therefore, it is possible to learn an appropriate weight by projecting it in the space Φ represented as {cφ|c ∈ R_{>0}, φ∈ Φ}. R_{>0} is a positive real number set.

The projection unit 205 may project to a space in which the condition of the component of each weight is non-negative or non-positive. For example, the projection unit 205 may project the updated weight (more precisely, each component φᵢ of the updated weight) in the following space Φ. If the condition of the component of each weight is non-negative, bᵢ=0, and if the condition of the component of each weight is non-positive, bᵢ=1.

$$[ Mathematical 5 ]$$

$$Φ = \{ ϕ \vert {( - 1 )}^{{b}_{i}} {ϕ}_{i} \geq 0 , {\sum }_{i} {( - 1 )}^{{b}_{i}} {ϕ}_{i} = 1 \}$$

Performing projection onto the space Φ is equivalent to performing projection after converting each component φᵢ of the weight into (−1)^{bi}φᵢ, and then re-converting each of the projected components φᵢ into (−1)^{bi}φᵢ.

For example, in the quadratic programming, φ^{T}h (x)=x^{T}Ax+b^{T}x in the above Expression (1) is expressed. In this case, the projection unit 205 may project the updated weight φ to the following space Φ.

$$[ Mathematical 6 ]$$

$$Φ := \{ ϕ = ( A , b ) \vert A = ( {α}_{ij} ) Positive definite matrix , {\sum }_{i} a \text{?} = 1 , Eigenvalue is δ or more \}$$

$$\text{?} \text{indicates text missing or illegible when filed}$$

If A is a d-order regular matrix, δ is a value larger than 0 and equal to or smaller than 1/d. Since the space Φ is also a bounded closed convex set, by projecting the space Φ, it is possible to prevent learning failure due to the weight value not converging and to prevent learning failure due to the optimum weight value becoming zero.

### (Learning Method)

A learning method of inverse reinforcement learning according to the present exemplary example embodiment will be described with reference to FIG. 4. FIG. 4 is a flowchart illustrating the flow of the learning method.

In S21, the acquisition unit 201 acquires the initial value of the weight and the trajectory data of the skilled person. For example, the acquisition unit 201 acquires each piece of the above-described data input via the input unit 23. A method of setting the initial value of the weight is arbitrary.

In S22, the optimization calculation unit 202 executes optimization calculation. As described above, various methods can be applied as the optimization calculation method. Here, in regard to the above Expression (1), if the following expression is set,

$$[ Mathematical 7 ]$$

$$a ( ϕ , {s}^{( n )} ) := {arg max}_{h ( x ) ∈ h ( X ( {s}^{( n )} ) )} {ϕ}^{T} h ( x )$$

then the following expression is obtained.

$$[ Mathematical 8 ]$$

$${max}_{x ∈ X ( {s}^{( n )} )} {ϕ}^{T} h ( x ) = {ϕ}^{T} a ( ϕ , {s}^{( n )} )$$

Therefore, Expression (1) can be rewritten as the following Expression (1)′.

$$[ Mathematical 9 ]$$

$${arg min}_{ϕ ∈ Φ} ( {\sum }_{n = 1}^{N} {ϕ}^{T} a ( ϕ , {s}^{( n )} ) - {\sum }_{n = 1}^{N} {ϕ}^{T} {a}^{( n )} ) , \qquad ( 1 )$$

In the above-described Expression (2), if β=0, the objective function F_{β}(φ) is rewritten as follows.

$$[ Mathematical 10 ]$$

$${F}_{0} ( ϕ ) = {\sum }_{n = 1}^{N} {ϕ}^{T} a ( ϕ , {s}^{( n )} ) - {\sum }_{n = 1}^{N} {ϕ}^{T} {a}^{( n )}$$

In S22, the optimization calculation unit 202 may calculate the value of the objective function F₀(φ). Then, in S23, the determination unit 203 determines necessity of updating the weight based on the result of the optimization calculation in S22. For example, the determination unit 203 may determine that it is not necessary to update the weight in a case where the value of the objective function F₀(φ) exceeds a predetermined threshold, and may determine that it is necessary to update the weight in a case where the value of the objective function F₀(φ) is equal to or less than the predetermined threshold. The determination unit 203 may also determine that the weight update is unnecessary in a case where the number of repetitions of the processing of S22 to S26 reaches a predetermined upper limit. If NO is determined in S23, the process proceeds to S24, and if YES is determined in S23, the process proceeds to S25.

In S24, the determination unit 203 causes the output unit 24 to output, as a learning result, the value of the weight in a case where it is determined in S23 that update is unnecessary, whereby the learning method in FIG. 4 ends. In S24, the reward function {a (φ, s⁽ⁿ⁾)}ₙ to which the weight is applied may be output instead of the weight, or the learning result may be stored in the storage unit 21 or the like without being output, and the process may be terminated.

In S25, the weight update unit 204 updates the weight. For example, in a case where the objective function F₀(φ) is used for the determination in S23, the weight update unit 204 may update the value of the weight φ as follows.

$$[ Mathematical 11 ]$$

$$ϕ ← ϕ - {a}_{k} {\sum }_{n = 1}^{N} ( a ( ϕ , {s}^{( n )} ) - {a}^{( n )} )$$

αₖ is a learning rate, and Σ(a (φ, s⁽ⁿ⁾)−a⁽ⁿ⁾) is a differential (sub-differential) in parentheses of Expression (1)′.

In S26, the projection unit 205 projects the weight updated in S25 to a predetermined space or set. For example, the projection unit 205 may project the updated weight to a closed subset of a vector space not including a zero vector, may project the updated weight to a closed convex set, or may project the updated weight to a bounded closed convex set.

The projection unit 205 may perform projection by different methods according to the reward function to be obtained. For example, as described above, the projection unit 205 may perform projection by different methods in the case of obtaining the reward function of the linear programming and the case of obtaining the reward function of the quadratic programming. In this manner, the projection unit 205 performs projection by different methods according to the reward function to be obtained, so that inverse reinforcement learning for various reward functions can be performed by one information processing device 2.

After S26, the process returns to S22, optimization calculation is executed based on the updated weight (S22), and necessity of updating the weight is determined (S23). Then, in a case where it is determined that the weight update is necessary (YES in S23), the process proceeds to S25, the weight is updated again, and the updated weight is projected in S26.

As described above, in the illustrated learning method, every time the weight update unit 204 performs the process of updating the weight (S25), the process of projecting the updated weight is performed (S26). Then, the weight update is repeated until a predetermined condition is satisfied (specifically, until NO is determined in S23).

As described above, the learning method according to the present exemplary example embodiment is a learning method for calculating a weight in a reward function represented by a weighted linear sum of feature amounts by inverse reinforcement learning, and includes updating the weight (S25), projecting the updated weight to a predetermined space or set (S26), and determining necessity of updating the weight based on the projected weight (S23).

According to this learning method, since the updated weight is projected to a predetermined space or set, it is possible to prevent learning failure (optimum weight value becomes zero, weight value does not converge, or the like) that may occur in a case where projection is not performed.

In S25, the weight update unit 204 may update the projected weight so that the sum of the Wasserstein distance and a value obtained by multiplying the entropy regularization term by a predetermined parameter (β in Expression (2)) is minimized. As described above, the Wasserstein distance is calculated as a difference between the average value of the reward calculated by the reward function during learning represented by using the projected weight and the average value of the reward calculated by the predetermined reward function represented by using the projected weight.

However, since the entropy regularization term is a term representing a difference between the feature amount of the trajectory data from which the maximum reward is obtained and the average value of the feature amounts of the trajectory data, the entropy regularization term does not become zero. For this reason, conventionally, in the case of performing the update as described above, it is necessary to bring β in Expression (2) close to zero for each weight update in order to converge learning.

On the other hand, since the information processing device 2 projects the weight to a predetermined space or set, it is possible to converge the learning even if β in Expression (2) is set to the same value regardless of the number of times of update. That is, according to the information processing device 2, in addition to the effect obtained by the information processing device 1 according to the first exemplary example embodiment, it is possible to obtain an effect of performing learning in consideration of the entropy regularization term with the parameter β set to the same value regardless of the number of times of update, and solving the problem of indefiniteness that occurs in a case where there is a plurality of reward functions.

In this case, the processing of updating the weight is expressed as follows.

$$[ Mathematical 12 ]$$

$$ϕ ← ϕ - {a}_{k} {\sum }_{n = 1}^{N} ( ( 1 - β ) a ( ϕ , {s}^{( n )} ) - β {a}^{max} ( ϕ ) - {a}^{( n )} )$$

a^{max} (φ) is a (a ∈ D (φ)) that maximizes the inner product with φ^{T}, and D (φ)={a⁽ⁿ⁾, a (φ, s⁽ⁿ⁾)|n}, as shown in the following expression.

$$[ Mathematical 13 ]$$

$${a}^{max} ( ϕ ) ∈ {arg max}_{a ∈ D ( ϕ )} \{ {ϕ}^{T} a \} ,$$

Further, on the assumption that the following inequality holds, the following expressions may be set.

$$[ Mathematical 14 ]$$

$${ϕ}^{T} {g}_{ϕ} ( {s}_{ini}^{( n )} ) \geq {ϕ}^{T} {a}^{( n )}$$

$$[ Mathematical 15 ]$$

$${a}^{max} ( ϕ ) = arg {max}_{{g}_{ϕ} ( {s}_{ini}^{( n )} )} {ϕ}^{T} {g}_{ϕ} ( {s}_{ini}^{( n )} )$$

### Modified Examples

An executing entity of each processing described in the above-described exemplary example embodiments is optional, and is not limited to the above-described examples. For example, a learning system having functions similar to those of the information processing devices 1 and 2 can be configured by a plurality of devices capable of communicating with each other. The executing entity of each processing illustrated in the flowchart illustrated in FIG. 4 may be one device (also referred to as a processor) or a plurality of devices (also referred to as a processor).

### [Example of Implementation by Software]

Some or all of the functions of the information processing devices 1 and 2 may be achieved by hardware such as an integrated circuit (IC chip) or may be achieved by software.

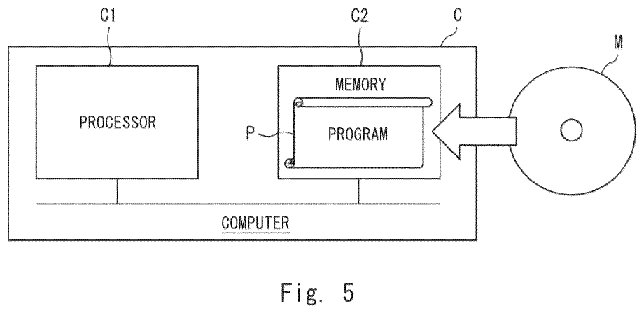

In the latter case, the information processing devices 1 and 2 are achieved by, for example, a computer that executes a command of a program that is software for achieving each function. An example of such a computer (hereinafter, referred to as a computer C) is illustrated in FIG. 5. The computer C includes at least one processor C1 and at least one memory C2. A program P (learning program) for causing the computer C to operate as the information processing device 1 or 2 is recorded in the memory C2. In the computer C, the processor C1 reads and executes the program P from the memory C2 to implement each function of the information processing device 1 or 2.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for loading the program P at the time of execution and temporarily storing various types of data. The computer C may further include a communication interface for transmitting and receiving data to and from other devices. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### [Supplementary Information 1]

The present disclosure is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present disclosure.

### [Supplementary Information 2]

Some or all the above-described example embodiments may be described as follows. However, the present disclosure is not limited to the following aspects.

### (Supplementary Note 1)

An information processing device that calculates a weight in a reward function represented by a weighted linear sum of feature amounts by inverse reinforcement learning, the information processing device including: a weight update means for updating the weight; a projection means for projecting the updated weight to a predetermined space or set; and a determination means for determining necessity of updating the weight based on the projected weight.

### (Supplementary Note 2)

The information processing device according to Supplementary Note 1, in which the predetermined space or set is a closed subset of a vector space that does not include a zero vector of which all elements are zero.

### (Supplementary Note 3)

The information processing device according to Supplementary Note 1 or 2, in which the predetermined space or set is a bounded closed convex set.

### (Supplementary Note 4)

The information processing device according to any one of Supplementary Notes 1 to 3, in which the weight update means updates the projected weight such that a sum of a Wasserstein distance, which is a difference between an average value of rewards calculated by the reward function during learning represented by using the projected weight and an average value of rewards calculated by a predetermined reward function represented by using the projected weight, and a value obtained by multiplying an entropy regularization term by a predetermined parameter is minimized, and in the update, the parameter is set to a same value regardless of a number of times of update.

### (Supplementary Note 5)

The information processing device according to any one of Supplementary Notes 1 to 4, in which the predetermined space or set is a space in which a condition of a component of each weight is non-negative or non-positive.

### (Supplementary Note 6)

A learning method for calculating a weight in a reward function represented by a weighted linear sum of feature amounts by inverse reinforcement learning, the learning method causing at least one processor to execute: updating the weight; projecting the updated weight to a predetermined space or set; and determining necessity of updating the weight based on the projected weight.

### (Supplementary Note 7)

A learning program that calculates a weight in a reward function represented by a weighted linear sum of feature amounts by inverse reinforcement learning, the learning program causing a computer to function as: a weight update means for updating the weight; a projection means for projecting the updated weight to a predetermined space or set; and a determination means for determining necessity of updating the weight based on the projected weight.

### [Supplementary Information 3]

Some or all the above-described example embodiments may be further described as follows. An information processing device that includes at least one processor and calculates a weight in a reward function represented by a weighted linear sum of feature amounts by inverse reinforcement learning, in which the processor executes a process of updating the weight, a process of projecting the updated weight to a predetermined space or set, and a process of determining necessity of updating the weight based on the projected weight.

The information processing device may further include a memory, and the memory may store a program for causing the processor to execute the process of updating the weight, the process of performing projection, and the process of determining necessity of updating. This program may be recorded in a non-transitory tangible computer-readable recording medium.

### REFERENCE SIGNS LIST

1 information processing device
11 weight update unit
12 projection unit
13 determination unit
2 information processing device
203 determination unit
204 weight update unit
205 projection unit

What is claimed is:

1. An information processing device that calculates a weight in a reward function represented by a weighted linear sum of feature amounts by inverse reinforcement learning, the information processing device comprising:
at least one memory storing instructions; and
at least one processor configured to execute the instructions to,
update the weight;
project the updated weight to a predetermined space or set; and
determine necessity of updating the weight based on the projected weight.

2. The information processing device according to claim 1, wherein the predetermined space or set is a closed subset of a vector space that does not include a zero vector of which all elements are zero.

3. The information processing device according to claim 1, wherein the predetermined space or set is a bounded closed convex set.

4. The information processing device according to claim 1, wherein
the at least one processor is further configured to execute the instructions to update the projected weight such that a sum of a Wasserstein distance, which is a difference between an average value of rewards calculated by the reward function during learning represented by using the projected weight and an average value of rewards calculated by a predetermined reward function represented by using the projected weight, and a value obtained by multiplying an entropy regularization term by a predetermined parameter is minimized, and
in the update, the parameter is set to a same value regardless of a number of times of update.

5. The information processing device according to claim 1, wherein the predetermined space or set is a space in which a condition of a component of each weight is non-negative or non-positive.

6. A learning method for calculating a weight in a reward function represented by a weighted linear sum of feature amounts by inverse reinforcement learning, the learning method causing at least one processor to execute:
updating the weight;
projecting the updated weight to a predetermined space or set; and
determining necessity of updating the weight based on the projected weight.

7. A non-transitory computer readable medium storing a learning program that calculates a weight in a reward function represented by a weighted linear sum of feature amounts by inverse reinforcement learning, the learning program causing a computer to function as:
a weight updater for updating the weight;
a projector for projecting the updated weight to a predetermined space or set; and
a determinator for determining necessity of updating the weight based on the projected weight.
